(19) United States
(12) Patent Application Publication
(10) Pub. No.: US 2007/0101415 A1
(43) Pub. Date: May 3, 2007

(54) Image processing apparatus, user authentication method and storage medium storing program for user authentication

(76) Inventor: Takanori Masui, Ebina-shi (JP)

Correspondence Address: GAUTHIER & CONNORS, LLP, 225 FRANKLIN STREET, SUITE 2300, BOSTON, MA, 02110, US

(21) Appl. No.: 11/403,084

(22) Filed: Apr. 12, 2006

(30) Foreign Application Priority Data
Nov. 2, 2005 (JP) 2005-319181

(51) Int. Cl. H04L 9/32

(52) U.S. Cl. 726/5

(57) ABSTRACT

There is provided an image processing apparatus including a memory that stores an authentication ID type which indicates a type of a user ID which is accepted by an authentication server and an input ID type which indicates a type of a user ID which is inputted by a user, an ID reception section that receives input of a user ID which corresponds to the input ID type, an authentication ID search section that accesses a directory server which stores a plurality of types of user ID in association with each other and searches for a user ID which corresponds to the authentication ID type and is associated with the inputted user ID, and an authentication processing section that accesses the authentication server to cause the authentication server to perform user authentication using the user ID corresponding to the authentication ID type which is specified as a result of the search.

### PRIORITY INFORMATION

This application claims priority to Japanese Patent Application No. 2005-319181 filed on Nov. 2, 2005, which is incorporated herein by reference in its entirety.

### BACKGROUND

1. Technical Field

The present invention relates to an image processing apparatus such as a digital multifunction apparatus or a digital copying apparatus, a network printer, a network scanner, and so on, and more particularly to network authentication of a party wishing to use such an image processing apparatus.

2. Related Art

User authentication has conventionally been performed for image processing apparatuses such as digital multifunction apparatuses. Conventionally, an authentication database for user authentication is provided in an image processing apparatus, so that user authentication is performed within the image processing apparatus. In recent years, on the other hand, a structure in which an authentication server is provided on a network such that user authentication for a great number of image processing apparatuses is performed collectively by the authentication server has become widespread.

### SUMMARY

In one aspect of the invention, there is provided an image processing apparatus including a first memory that stores search account information which is used for performing a search of a directory server which stores a plurality of types of user ID of a user in association with each other, a second memory that stores an authentication ID type which indicates a type of a user ID which is accepted by an authentication server and an input ID type which indicates a type of a user ID which a user inputs, an ID reception section that receives input of a user ID which corresponds to the input ID type, an authentication ID search section that accesses the directory server using the search account information and searches for a user ID which corresponds to the authentication ID type and is associated with the inputted user ID, and an authentication processing section that accesses the authentication server to cause the authentication server to perform user authentication using the user ID corresponding to the authentication ID type which is specified as a result of the search.

### BRIEF DESCRIPTION OF THE DRAWINGS

These and other aspects of the disclosure will become apparent from the following description read in conjunction with the accompanying drawings wherein the same reference numerals have been applied to corresponding parts and in which:

FIG. 1 is a view showing a system structure according to an embodiment of the present invention;

FIG. 2 is a view illustrating example data content of user information managed by a directory server; and

FIG. 3 is a flowchart showing a process flow according to the embodiment.

### DETAILED DESCRIPTION

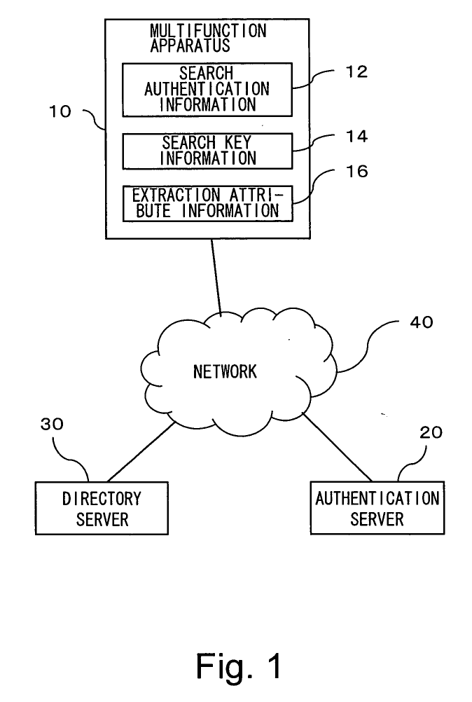

FIG. 1 schematically shows the structure of a job processing system according to an embodiment of the present invention. As shown in FIG. 1, in this system, a multifunction apparatus 10, an authentication server 20, and a directory server 30 are connected to a network 40, such as the Internet or LAN (local area network).

The multifunction apparatus 10 provides functions of a scanner, a printer, a copying machine, and so on. The multifunction apparatus 10 may have an information processing function for requesting various servers and multifunction apparatuses on the network 40 to perform processing, for receiving the processed result, and for applying a further process thereto. An example of cooperation between the multifunction apparatus 10 and other apparatuses on the network 40 as described above is disclosed in Japanese Patent Laid-Open Publication No. 2004-153472 of the present applicant.

The multifunction apparatus 10 requests authentication when a user attempts to use the apparatus. Here, various levels of authentication may be requested. For example, use of the multifunction apparatus 10 as a whole may be permitted only when user authentication is successful, or user authentication may be requested in order to use only a portion of the functions (including a function of using a server or the like on the network 40) provided by the multifunction apparatus 10. Which case is used for requesting authentication may be determined by the security policy implemented by a manager of the overall system or of the multifunction apparatus 10.

According to the present embodiment, user authentication for use of the multifunction apparatus 10 is performed by external authentication at the authentication server 20 provided on the network 40. The authentication server 20 performs user authentication using an existing network authentication scheme such as LDAP authentication, Kerberos authentication, SMB authentication, etc. A combination of authentication user ID and authentication information is registered in the authentication server 20 for each registered user. One example of authentication information is a password. Alternatively, the authentication information may be biometric information including fingerprint data, iris data, and so on.

To initiate user authentication by the authentication server 20, it is necessary that an authentication user ID which can be recognized by the authentication server 20 be supplied to the authentication server 20. In the case of LDAP authentication, for example, a user DN (Distinguished Name) may be used as the authentication user ID. However, such a user DN is relatively lengthy, and requires significant time and user labor to enter through an input device (e.g. GUI (Graphical User Interface) or numeral buttons on a liquid crystal touch panel) with relatively poor operability, and is not always easy for a user to remember. Similarly, in the case of Kerberos authentication or SMB authentication, the authentication user ID is often difficult for a user to remember.

The system according to the present embodiment causes a user to input, as a user ID, information which is easy for the user to remember, such as the user's email address, telephone number, employee number, or the like, in the multifunction apparatus 10. The multifunction apparatus 10 then obtains an authentication user ID corresponding to the input user ID from the directory server 30 and supplies the authentication user ID to the authentication server 20, thereby reducing the user's burden associated with inputting the authentication user ID in the multifunction apparatus 10.

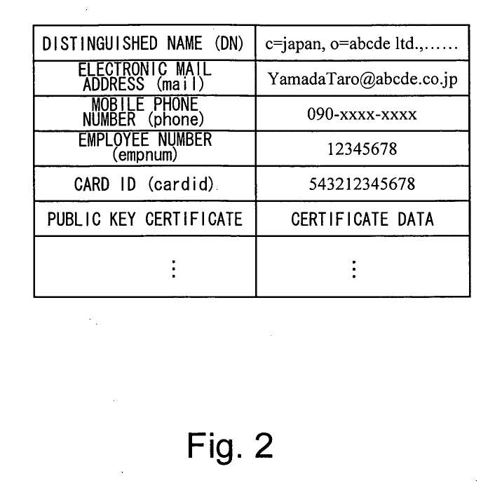

The directory server 30 conforms to an authentication scheme such as LDAP or the like and stores and manages various types of attribute information concerning registered users. FIG. 2 shows example user information which is stored and managed by the directory server 30. In this example case which complies with LDAP, in association with each user, various types of attribute information including an electronic mail address, a mobile phone number, an employee number, a card ID of user's ID card (such as an employee ID card), the user's public key certificate, etc., are registered in conjunction with the user's DN in the directory server 30. The directory server 30, in response to the request from a user on the network, searches for and provides these attribute information items which are thus registered.

Here, the directory server 30 accepts a search request only from a user having a search account, with a “user” in this regard not being limited to a human being, but including apparatuses, such as a multifunction apparatus, as “users” of the directory server 30. More specifically, the directory server 30 holds account information (including a user name and authentication information, for example) concerning users whose search requests are permitted, and, when receiving a search request from a user, the directory server 30 permits search for user information only if the user presents correct authentication information.

Accordingly, in the present embodiment, the directory server 30 has a search account of the multifunction apparatus 10 registered therein (see FIG. 1). The multifunction apparatus 10, in turn, has registered therein authentication information (search authentication information 12) for the search account. The search authentication information 12 includes an account name of the search account and authentication information such as a password and other information.

According to the exemplary embodiment, the user ID input by a user to the multifunction apparatus 10 is sent to the directory server 30, which searches for the authentication user ID corresponding to the user ID which is received. As the user ID to be input by a user to the multifunction apparatus 10, one of the various types of user attributes registered in the directory server 30 is selected. Information such as a user's electronic mail address, mobile phone number, employee number, and so on described above is identification information which can identify a user in a substantially unique manner and which also can be expected to be remembered by the user. It may be easy for a user to use such a user attribute as the user ID. Which of the user attributes registered in the directory server 30 must be input by the user is determined by a manager of the multifunction apparatus 10 and set in the multifunction apparatus 10 as search key information 14. Here, such information is referred to as the “search key” information because the directory server 30 uses this input user ID as a key for searching the user information having that key. When an electronic mail address is input as the user ID, for example, the search key information 14 is an attribute name “mail” representing an electronic mail address. When requesting the directory server 30 to perform a search, the multifunction apparatus 10 sends, as search key values, the user ID input by the user, along with the search key information 14 indicative of the attribute type of the user ID, to the directory server 30.

Further, in order to enable the directory server 30 to understand to which of the user attributes the authentication user ID for the authentication server 20 corresponds, the multifunction apparatus 10 also sends extraction attribute information 16 representing a user attribute type to which the authentication user ID corresponds to the directory server 30 when requesting for search. Here, this information is referred to as the “extraction attribute” because it represents an attribute to be extracted from the user information which is specified, as a result of search, as information satisfying the search key. The-extraction attribute information 16 is preset in the multifunction apparatus 10 by a manager of the multifunction apparatus 10. More specifically, attributes corresponding to the information types of the authentication user ID which can be accepted by the authentication server 20 are obtained from a group of the attributes registered in the directory server 30, and their attribute names are registered in the extraction attribute information 16. When the authentication server 20 accepts a user's distinguished name (DN) as the authentication user ID, for example, the extraction attribute information 16 is “DN”.

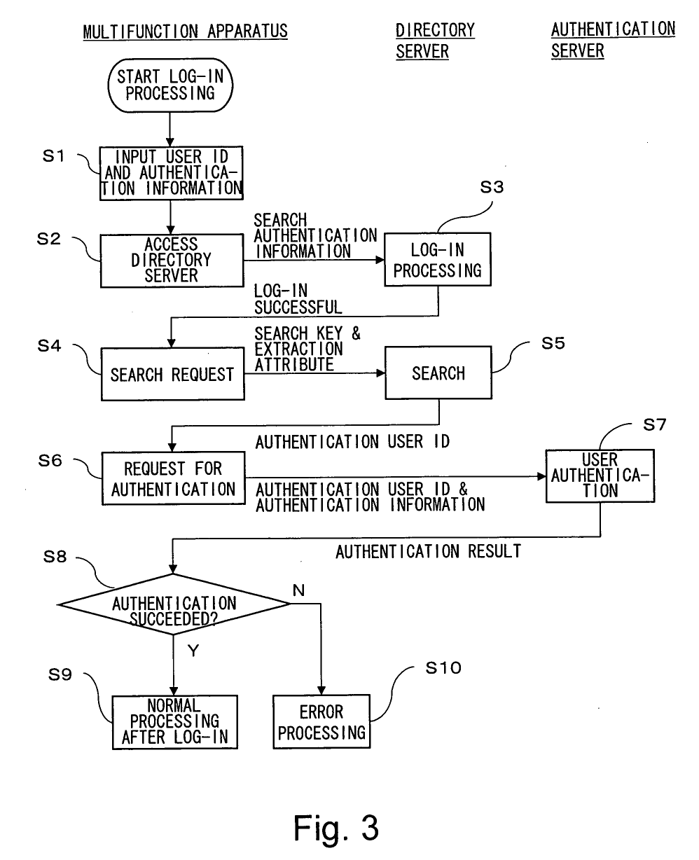

A flow of the user authentication process according to the present embodiment will be described with reference to FIG. 3.

The multifunction apparatus 10, when receiving a user instruction to perform a process requiring user authentication, causes a display device provided in the multifunction apparatus 10 to display an input screen for authentication. If user authentication is requested so as to use the multifunction apparatus 10 itself, an initial screen, for example, corresponds to the input screen for authentication. This input screen includes an entry space for a user ID and an entry space for a password. By indicating, in the entry space for user ID, a description designating the type of user ID which the multifunction apparatus requests, such as “your electronic mail address”, for example, a user can easily understand what type of information to input. The password which the multifunction apparatus 10 requests the user to input is an authentication password which is registered in the authentication server 20. While the authentication user ID which is allocated to a user is not necessarily easy for the user to remember in consideration of uniqueness of the ID, it is very likely that a user remembers the password which can be determined as desired by the user.

Here, the multifunction apparatus 10 may request the user to input other forms of authentication information such as biometric authentication information, for example. In such a case, the input screen for authentication displays message or an image which prompts reading of a user's fingerprint by a fingerprint reading accessory device, for example, thereby urging the user to input such authentication information.

When the user ID and the authentication information is input by the user through the input screen (S1), the multifunction apparatus 10 uses the search authentication information to log onto the directory server 13 (S2). Here, the user ID or the like is input manually by the user through a soft keyboard or numeric keys displayed on the display device, such as a liquid crystal touch panel. The directory server 30 confirms whether or not the search authentication information 12 which is received is correct, and permits log-in if the authentication information 12 is correct (S3). If the authentication information 12 is not correct, log-in is not permitted and an error process is performed.

When log-in is permitted by the directory server 30, the multifunction apparatus 10 sends the search key (i.e. the search key information 14 and the user ID which is input) and the extraction attribute information 16 to the directory server 30 so as to request search (S4). The directory server 30, receiving the search request, searches, among the user information items which are registered, for user information whose value of the attribute designated by the search key information 14 is the same as the user ID value of the search key which is received, and then extracts a value of the attribute designated by the extraction attribute information 16 from the user information which is specified by search (S5). The value which is thus extracted is an authentication user ID, which is returned from the directory server 30 to the multifunction apparatus 10 as the search result.

The multifunction apparatus 10 then sends the authentication user ID which is received from the directory server 30 and the authentication information which is input by the user to the authentication server 20 to thereby request a user authentication process (S6). The authentication server 20, receiving the request from the user, compares a combination of the authentication user ID and the authentication information which is received with the registered user ID and authentication information to determine whether or not the received information is correct (S7). When it is determined, as a result of comparison, that the received information is correct, the authentication server 20 returns, as the authentication result, information indicative of success of user authentication to the multifunction apparatus 10, whereas when it is determined that the received information is not correct, the authentication server 20 returns, as the authentication result, information indicative of failure of user authentication to the multifunction apparatus 10.

The multifunction apparatus 10, receiving the authentication result, determines whether or not the authentication result indicates success of the authentication (S8). When it is determined that the authentication is successful, the multifunction apparatus 10 permits log-in of the user and performs the process requested by the user (S9). If, on the other hand, the authentication fails, the multifunction apparatus 10 performs a predetermined error process (S10). For example, the multifunction apparatus 10 may display a screen informing the user of failure of the authentication.

In the process described above, by protecting. (encrypting) the communication between the multifunction apparatus 10 and the directory server 30 and the communication between the multifunction apparatus 10 and the authentication server 20 using a protocol for transmission path protection such as SSL (Secure Socket Layer), a risk of leakage of highly confidential information such as the authentication information can be reduced.

Further, when user information whose uniqueness for each user is ensured or which is very likely to be unique for each user, such as an electronic mail address and a mobile phone number, is used as the user ID which the user is requested to input, it is usually possible for the directory server 30 to uniquely specify one user corresponding to each user ID. It is possible, however, to take into consideration cases where a plurality of users may be specified as a result of search with regard to the user ID input by a single user. In such a case, the directory server 30 may return information indicating that a plurality of users are specified as a result of search or information merely indicating an error to the multifunction apparatus 10, and the multifunction apparatus 10, upon receiving such information, may then cause the display device to display message indicating the authentication error, for example. In this case, the authentication process for log-in is terminated.

Alternatively, it is possible that each of the authentication user IDs specified by the directory server 30 as a result of search may be displayed on the display device of the multifunction apparatus 10 to allow the user to select one corresponding to their authentication user ID among these IDs. In this case, the authentication user ID which is selected is sent to the authentication server 20 together with the password.

Also, while in the above example, a user inputs the complete information of an input user ID in the multifunction apparatus 10, such as entering the entire character string of an electronic mail address, a method according to the present embodiment is not limited to this structure, and it is possible to prompt a user to input only a portion of the user ID, with the remaining information being supplemented by the multifunction apparatus 10. For example, in a case where the multifunction apparatus 10 is provided within a certain company and is used only by staff of the company, a domain name after an at mark (“@”) of an electronic mail address of each user is prestored in the multifunction apparatus 10 and each user is caused to input only a mail account portion before the at mark, so that the multifunction apparatus 10 can add the character string after the at mark to the character string forming the mail account to complete the mail address, which is then sent to the directory server 30.

In addition, while in the above example, a user inputs a user ID manually to the multifunction apparatus 10, it is also possible to cause a reader associated with the multifunction apparatus 10 to read an authentication token such as an IC card and a USB memory. In such a case, the multifunction apparatus 10 sends, together with the password input by a user, a token ID (a card ID in the case of an IC card) which is read from the authentication token, to the directory server 30. The directory server then searches for an authentication user ID corresponding to the token ID and returns the authentication user ID which is specified to the multifunction apparatus 10. Here, the token ID of the token used by a user is limited to ID information registered in the directory server 30 as one attribute of the user. As the token ID such as a card ID generally constitutes identification information of the token itself, which portion in the memory area of the token should be read is previously specified according to the standard, specifications or the like, and therefore such a token ID is easy for the reader to handle.

However, the authentication user ID for the authentication server 20 generally differs from the token ID. Therefore, even if the authentication user ID can be stored in a token, the structure or process of the reader becomes more complicated in order to allow the reader to appropriately detect and read the authentication user ID, because where in the memory area of the token the authentication user ID is stored is not generally fixed. On the other hand, by converting a token ID which is easy to read into an authentication user ID at the directory server 30 and using the authentication user ID thus obtained for authentication at the authentication server 20, as in the present embodiment, the reader can have a simple structure in which the reader simply reads the token ID.

Further, while in the above example, the authentication server 20 and the directory server 30 are provided separately on the network 40, these separate devices can be combined into a single device. For example, when LDAP is used as a protocol for directory search and LDAP authentication is used as an authentication scheme, a single LDAP server can be used to provide a directory service and an authentication service in association with each other.

Moreover, while an example multifunction apparatus 10 is described above, the authentication processing method according to the present embodiment as described above is applicable to image processing apparatuses other than multifunction apparatuses, such as a printer, scanner, and a copying apparatus.

Although an exemplary form of the present invention has been described with a certain degree of particularity using specific examples, it is to be understood that the invention is not limited these example. Further, it is to be understood by those skilled in the art that various changes and modifications may be made without departing from the spirit and scope of the invention.

What is claimed is:

1. An image processing apparatus comprising:
a first memory that stores search account information which is used for performing a search of a directory server which stores a plurality of types of user ID of a user in association with each other;
a second memory that stores an authentication ID type which indicates a type of a user ID which is accepted by an authentication server and an input ID type which indicates a type of a user ID which a user inputs;
an ID reception section that receives input of a user ID which corresponds to the input ID type;
an authentication ID search section that accesses the directory server using the search account information and searches for a user ID which corresponds to the authentication ID type and is associated with the inputted user ID; and
an authentication processing section that accesses the authentication server to cause the authentication server to perform user authentication using the user ID corresponding to the authentication ID type which is specified as a result of the search.

2. The image processing apparatus according to claim 1, wherein
when a plurality of user IDs corresponding to the authentication ID type are specified as a result of the search performed by the authentication ID search section, an error process is performed.

3. The image processing apparatus according to claim 1, further comprising:
a selection section that, when a plurality of user IDs corresponding to the authentication ID type are specified as a result of the search performed by the authentication ID search section, presents the plurality of user IDs to a user to allow the user to select one from among the plurality of user IDs, wherein
the authentication processing section causes the authentication server to perform user authentication using the selected user ID.

4. The image processing apparatus according to claim 1, wherein
the ID input section is a reader which reads a token ID of an authentication token as the user ID corresponding to the input ID type.

5. The image processing apparatus according to claim 1, wherein
the ID input section adds a predetermined data item to data input by the user to thereby complete the user ID corresponding to the input ID type.

6. A user authentication method in an image processing apparatus, comprising:
storing search account information which is used for performing a search of a directory server which stores a plurality of types of user ID of a user in association with each other;
storing an authentication ID type which indicates a type of a user ID which is accepted by an authentication server and an input ID type which indicates a type of a user ID which a user inputs;
receiving input of a user ID which corresponds to the input ID type from a user;
accessing the directory server using the search account information;
searching for a user ID which corresponds to the authentication ID type and is associated with the inputted user ID; and
accessing the authentication server to cause the authentication server to perform user authentication using the user ID corresponding to the authentication ID type which is specified as a result of the search.

7. The method according to claim 6, further comprising:
performing an error process when a plurality of user IDs corresponding to the authentication ID type are specified as a result of the search.

8. The method according to claim 6, further comprising:
when a plurality of user IDs corresponding to the authentication ID type are specified as a result of the search, presenting the plurality of user IDs to a user to allow the user to select one from among the plurality of user IDs; and
causing the authentication server to perform user authentication using the selected user ID.

9. The method according to claim 6, wherein
in receiving input of a user ID corresponding the input ID type from the user, a token ID of an authentication token is read as the user ID corresponding to the input ID type.

10. The method according to claim 6, further comprising:
adding a predetermined data item to data inputted by the user to thereby complete the user ID which corresponds to the input ID type.

11. A storage medium readable by a computer storing a program for user authentication executable by the computer to perform a function comprising:
storing search account information which is used for performing a search of a directory server which stores a plurality of types of user ID of a user in association with each other;
storing an authentication ID type which indicates a type of a user ID which is accepted by an authentication server and an input ID type which indicates a type of a user ID which a user inputs;
receiving input of a user ID which corresponds to the input ID type from a user;
accessing the directory server using the search account information;
searching for a user ID which corresponds to the authentication ID type and is associated with the inputted user ID; and
accessing the authentication server to cause the authentication server to perform user authentication using the user ID corresponding to the authentication ID type which is specified as a result of the search.

12. The storage medium according to claim 11, the function further comprising:
performing an error process when a plurality of user IDs corresponding to the authentication ID type are specified as a result of the search.

13. The storage medium according to claim 11, the function further comprising:
when a plurality of user IDs corresponding to the authentication ID type are specified as a result of the search, presenting the plurality of user IDs to a user to allow the user to select one from among the plurality of user IDs; and
causing the authentication server to perform user authentication using the selected user ID.

14. The storage medium according to claim 11, wherein
in receiving input of a user ID corresponding the input ID type from the user, a token ID of an authentication token is read as the user ID corresponding to the input ID type.

15. The storage medium according to claim 11, the function further comprising:
adding a predetermined data item to data inputted by the user to thereby complete the user ID which corresponds to the input ID type.

16. An image processing apparatus comprising:
a memory that stores an authentication ID type which indicates a type of a user ID which is accepted by an authentication server and an input ID type which indicates a type of a user ID which is inputted by a user;
an ID reception section that receives input of a user ID which corresponds to the input ID type;
an authentication ID search section that accesses a directory server which stores a plurality of types of user ID in association with each other and searches for a user ID which corresponds to the authentication ID type and is associated with the inputted user ID; and
an authentication processing section that accesses the authentication server to cause the authentication server to perform user authentication using the user ID corresponding to the authentication ID type which is specified as a result of the search.

17. A user authentication method in an image processing apparatus, comprising:
storing an authentication ID type which indicates a type of a user ID which is accepted by an authentication server and an input ID type which indicates a type of a user ID which is inputted by a user;
receiving input of a user ID which corresponds to the input ID type;
accessing a directory server which stores a plurality of types of user ID in association with each other;
searching for a user ID which corresponds to the authentication ID type and is associated with the inputted user ID; and
accessing the authentication server to cause the authentication server to perform user authentication using the user ID corresponding to the authentication ID type which is specified as a result of the search.

18. A storage medium readable by a computer storing a program for user authentication executable by the computer to perform a function comprising:
storing an authentication ID type which indicates a type of a user ID which is accepted by an authentication server and an input ID type which indicates a type of a user ID which is inputted by a user;
receiving input of a user ID which corresponds to the input ID type;
accessing a directory server which stores a plurality of types of user ID in association with each other;
searching for a user ID which corresponds to the authentication ID type and is associated with the inputted user ID; and
accessing the authentication server to cause the authentication server to perform user authentication using the user ID corresponding to the authentication ID type which is specified as a result of the search.
